(19) United States
(12) Patent Application Publication
(10) Pub. No.: US 2007/0009180 A1
(43) Pub. Date: Jan. 11, 2007

(54) Real-time face synthesis systems

(76) Inventors: Ying Huang, Beijing (CN); Hao Wang, Beijing (CN); Qing Yu, Beijing (CN); Hui Zhang, Beijing (CN)

Correspondence Address: SILICON VALLEY PATENT AGENCY, 7394 WILDFLOWER WAY, CUPERTINO, CA, 95014, US

(21) Appl. No.: 11/456,318

(22) Filed: Jul. 10, 2006

(30) Foreign Application Priority Data
Jul. 11, 2005 (CN) 200510082755.1

(51) Int. Cl. G06K 9/36

(52) U.S. Cl. 382/276

(57) ABSTRACT

The present invention discloses techniques for producing a synthesized facial model synchronized with voice. According to one embodiment, synchronizing colorful human or human-like facial images with voice is carried out as follows: determining feature points in a plurality of image templates about a face, wherein the feature points are largely concentrated below eyelids of the face, providing a colorful reference image reflecting a partial face image, dividing the reference image into a mesh including small areas according to the feature points on the image templates, storing chromaticity data of respective pixels on selected positions on the small areas in the reference image, coloring each of the templates with reference to the chromaticity data, and processing the image templates to obtain a synthesized image.

### BACKGROUND OF THE INVENTION

1. Field of the Invention

The present invention generally relates to the area of image simulation technology, more particularly to techniques for synchronizing colorful human or human-like facial images with voice.

2. Description of the Related Art

Face model synthesis means to synthesize various human or human-like faces including facial expressions and face shapes using computing techniques. In general, face model synthesis includes many facets, for example, the human facial expression synthesis that is to synthesize various human facial expressions (e.g., laugh or angry) based on data. To synthesize the shape of a mouth, voice data may be provided to synthesize the mouth shape and chin to make a facial expression in synchronization with the voice data.

When people speak, their voice and facial expressions are totally different but are not completely independent. When watching a translated film, one would feel discomfort or a character performs awkward when the translated or dubbed voice and the mouth movement of the character are mismatched. Such a translated film would be only enjoyed when voice and corresponding images of mouth movement of actors are substantially matched.

A real human face synthetic technique based on voice has two exemplary applications, one being the animated cartoon movies, and the other being voice-image transmission over long-distance. In making an animated cartoon movie, the facial expression of a character could not be produced by a camera, thus different models of the facial expression of the character have to be pre-made. Human-like facial images are then synthesized in accordance with a corresponding voice. In voice-image transmission over long-distance, human-like facial images are synthesized in accordance with transmitted voices so that synthesized live scene can be provided at a receiving end.

There have been some efforts in the area of synchronizing colorful human or human-like facial images with voice. For example, C. Bregler, M. Covell, and M. Slaney. “Video Rewrite: Driving visual speech with audio”, ACM SIGGRAPH '97, 1997 publishes one human face synthetic method that directly finds a facial model corresponding to a certain phoneme from the original video, then pastes this section of the face model to a background video to obtain a real human face video data. Such synthesis effect is relatively good, especially the video image output appears nature. However, the approach involves too much computation, too many training data. For only one phoneme, there are several thousands of human face models, which is difficult to be realized in real time.

M. Brand, “Voice Puppetry”, ACM SIGGRAPH '99, 1999. “Video Rewrite” discloses a human face synthetic method that takes out the facial feature point and establishes the facial feature status, combines an input voice feature vector in accordance with a hidden Markovian algorithm to produce the facial feature points sequence. As a result, the human face video sequence is generated. But this algorithm can not be realized in real-time, and the synthesis result is relatively monotonic.

Ying Huang, Xiaoqing Ding, Baining Guo, and Heung-Yeung Shum. “Real-time face synthesis driven by voice”, CAD/Graphics' 2001, August 2001, disclose a human face synthetic method that only gets a cartoon human face sequence. It does not provide an appropriate coloring means, so the colorful face sequence can not be obtained. Furthermore, in this method, the voice feature is directly corresponding to the facial model sequence. When training the data, the feature points on the human face are not only distributed on the mouth shape, but also distributed on the parts such as chin. So, the chin movement information is included in the training data. However, when speaking, a head could shake. The experiment result shows that the captured training data of the chin is not very accurate, which makes the movement of the chin in the synthesized human face sequence is not continuous and unnatural, which adversely affects the integrated synthesis effect.

Therefore, there is a need for effective techniques for synchronizing colorful human or human-like facial images with voice.

### SUMMARY OF THE INVENTION

This section is for the purpose of summarizing some aspects of the present invention and to briefly introduce some preferred embodiments. Simplifications or omissions may be made to avoid obscuring the purpose of the section as well as in the title and abstract. Such simplifications or omissions are not intended to limit the scope of the present invention.

The present invention discloses techniques for producing a synthesized facial model synchronized with voice. According to one aspect of the present invention, synchronizing colorful human or human-like facial images with voice is carried out as follows:
determining feature points in a plurality of image templates about a face, wherein the feature points are largely concentrated below eyelids of the face;
providing a colorful reference image reflecting a partial face image;
dividing the reference image into a mesh including small areas according to the feature points on the image templates;
storing chromaticity data of respective pixels on selected positions on the small areas in the reference image;
coloring each of the templates with reference to the chromaticity data; and
processing the image templates to obtain a synthesized image.

The present invention may be implemented as a method, an apparatus or a part of a system. According to one embodiment, the present invention is an apparatus comprising a human face template unit, a chromaticity information unit, a mouth shape-face template matching unit, a smoothing processing unit, and a coloring unit. The human face template unit is configured to determine mouth shape feature points from a sequence of image templates about a face, wherein the mouth shape feature points are used to divide a reference image into a mesh comprised of many small areas. The chromaticity information unit is configured to store chromaticity data of selected pixels of each triangle in the mesh. The mouth shape-face template matching unit is configured to put a synthesized mouth shape to a corresponding human face template via a matching processing, and obtain a human face template sequence. The smoothing processing unit is configured to carry out a smoothing processing on each of the image templates. The coloring unit is configured to store the chromaticity data that configured to color corresponding areas and positions that have been divided according to the feature points, wherein the coloring unit further calculates or expands chromaticity data of other pixels on the human face.

Other objects, features, and advantages of the present invention will become apparent upon examining the following detailed description of an embodiment thereof, taken in conjunction with the attached drawings.

### BRIEF DESCRIPTION OF THE DRAWINGS

These and other features, aspects, and advantages of the present invention will be better understood with regard to the following description, appended claims, and accompanying drawings as follows:

FIG. 1 shows an exemplary system functional block diagram that includes three major modules: a training module, a synthesis module and an output module;

FIG. 2 shows an operation of selecting more than ten standard human face images corresponding to different mouth shapes;

FIG. 3 shows a part of face images from which various feature points are determined;

FIG. 4 shows a human face with triangles based on a human face template in one embodiment of the present invention;

FIG. 5A and FIG. 5B show, respectively and as an example, selected sixteen points and six small triangles when coloring an entire triangle that is being divided into six small triangles;

FIG. 6 is a sketch map of coloring the internal pixels in the triangle n one embodiment of the present invention;

FIG. 7 shows colored synthesized partial faces under the eyelids in one embodiment of the present invention;

FIG. 8 shows a colored synthesized face in one embodiment of the present invention;

FIG. 9 is a cartoon-like synthesized human face in one embodiment of the present invention;

FIG. 10 is an exemplary block diagram of an output module according to one embodiment of the present invention; and

FIG. 11 shows a flowchart or process of synthesizing a human face according to one embodiment of the present invention.

### DETAILED DESCRIPTION OF THE PREFERRED EMBODIMENTS

In the following description, numerous specific details are set forth in order to provide a thorough understanding of the present invention. However, it will become obvious to those skilled in the art that the present invention may be practiced without these specific details. The descriptions and representations herein are the common means used by those experienced or skilled in the art to most effectively convey the substance of their work to others skilled in the art. In other instances, well-known methods, procedures, components, and circuitry have not been described in detail to avoid unnecessarily obscuring aspects of the present invention.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments. Further, the order of blocks in process flowcharts or diagrams representing one or more embodiments of the invention do not inherently indicate any particular order nor imply any limitations in the invention.

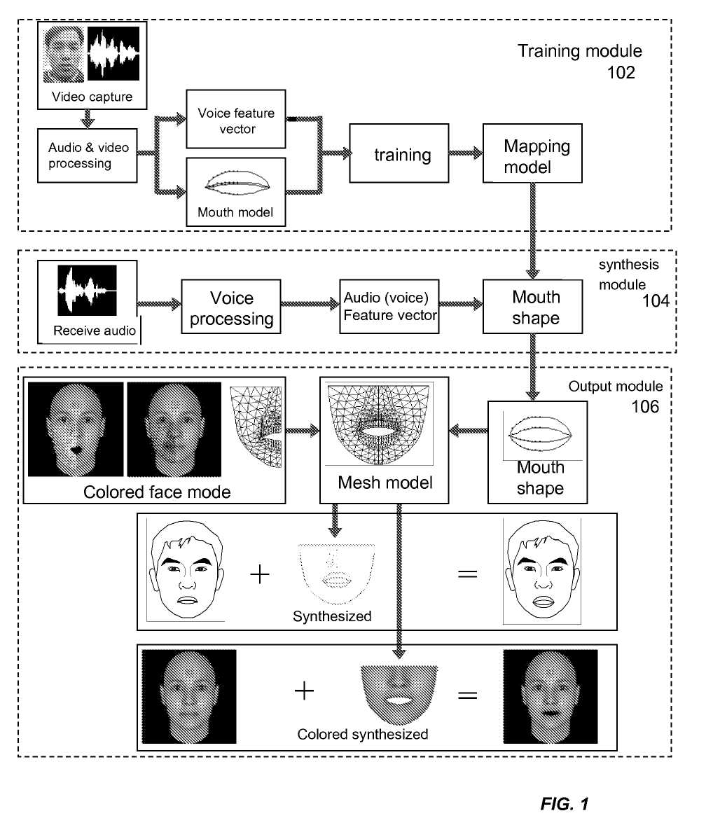

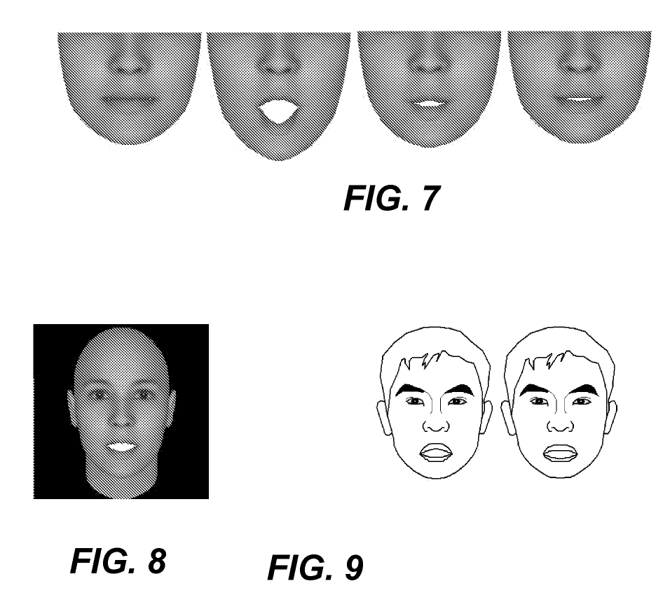

Embodiments of the present invention are discussed herein with reference to FIGS. 1-11. However, those skilled in the art will readily appreciate that the detailed description given herein with respect to these figures is for explanatory purposes as the invention extends beyond these limited embodiments.

Referring now to the drawings, in which like numerals refer to like parts throughout several views. FIG. 1 shows an exemplary system functional block diagram 100 that includes three major modules: a training module 102, a synthesis module 104 and an output module 106. The training module 102 is used to capture video and audio (voice) data, conduct video and voice data processing, and establish mapping models of a mouth shape sequence and a voice feature vector sequence. In one embodiment, the training module 102 records tester's voice data and a corresponding front facial image sequence, manually or automatically mark the corresponding human face, and establish a mouth shape model.

In operation, the training module 102 is configured to determine the Mel-frequency Cepstrum Coefficient (MFCC) vector from the voice data, and subtract an average voice feature vector therefrom to obtain a voice feature vector. With the mouth shape model and voice feature vectors, some representative sections of the mouth shape sequence are sampled to establish a matched real-time mapping model based on the voice feature vectors.

In addition, in order to work with all input voice data, many mouth shapes are provided and the corresponding HMM model of each mouth shape is trained. There are many ways to perform the training process. One of them is to use one of three methods listed in the background section. Essentially, it adopts the mapping model based on the sequence matching and the HMM model. However, it should be noted that there is at least one difference in the present invention that is different from the prior art process, namely, it processes the mouth shape data in the human face, but does not demarcate and process other parts on the face, such as chin, thus it avoids the data distortion caused by possible human face movement.

The synthesis module 104 is configured to determine a voice feature vector from the received voice, and forward it to the mapping model to synthesize the mouth shape sequence. According to one embodiment, the synthesis module 104 is configured to perform as follows: it receives the audio (voice), calculates the MFCC feature vector of the input voice, matches the processed feature vector with the voice feature vector sequence in one of the mapping models, outputs a mouth shape. If the matching rate is low, the corresponding mouth shape is calculated with the HMM model, then the synthesis module 104 conducts weighted smoothness on the current mouth shape and its preceding mouth shapes, and outputs an ultimate result.

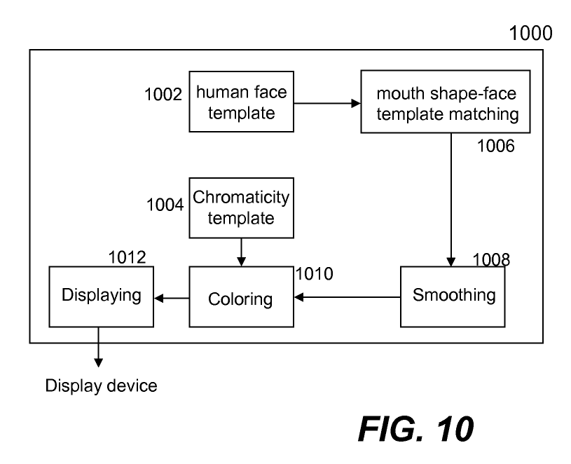

It may be understood that what is output and matched is the mouth shape, not the face shape. Accordingly what is synthesized by the synthesis module is the mouth shape sequence of a facial model, it does not include any movement information of the other parts of the human face, or any other color information. While the purpose of the output module is to extend the mouth shape sequence into more real cartoon like or colored face sequence, as shown in FIG. 10, the output module 1000 further includes a human face template unit 1002, a chromaticity information unit 1004, a mouth shape-face template matching unit 1006, a smoothing processing unit 1008, a coloring unit 1010 and a display unit 1012.

The human face template unit 1002 is used to store various human face templates encompassing various mouth shape feature points. Because when people speak, the part above the eyelid basically does not move, so the human face templates in one embodiment of the present invention include the marked feature points below the eyelid, which can indicate the movements of the mouth, shape, chin and nose, and etc. One of the reasons to focus only on the part below the eyelid is to simplify the computation and improve the synthesis efficiency.

The chromaticity information unit 1004 is used to store the chromaticity data of selected pixel(s) of each triangle in the mesh of a colorful human face. These triangles are formed according to the feature points of the human face template corresponding to a reference human face. The mouth shape-face template matching unit 1006 is configured to put a synthesized mouth shape to a corresponding human face template via a matching processing (e.g., a comparability algorithm), and obtains a human face template sequence corresponding to the mouth shape sequence.

The smoothing processing unit 1008 is used to carry out a smoothing processing on each face template in the face template sequence. The coloring unit 1010 is used to store the abovementioned chromaticity data that is used to color the corresponding areas and positions that have been divided according to the feature points of the human face. The coloring unit 1010 further calculates or expands the chromaticity data of other pixel points on the human face. The display unit 1012 is used to display the colored human face. In one embodiment, when displaying, a background image including the part above the eyelid may be superimposed, leading to a complete colored human face image.

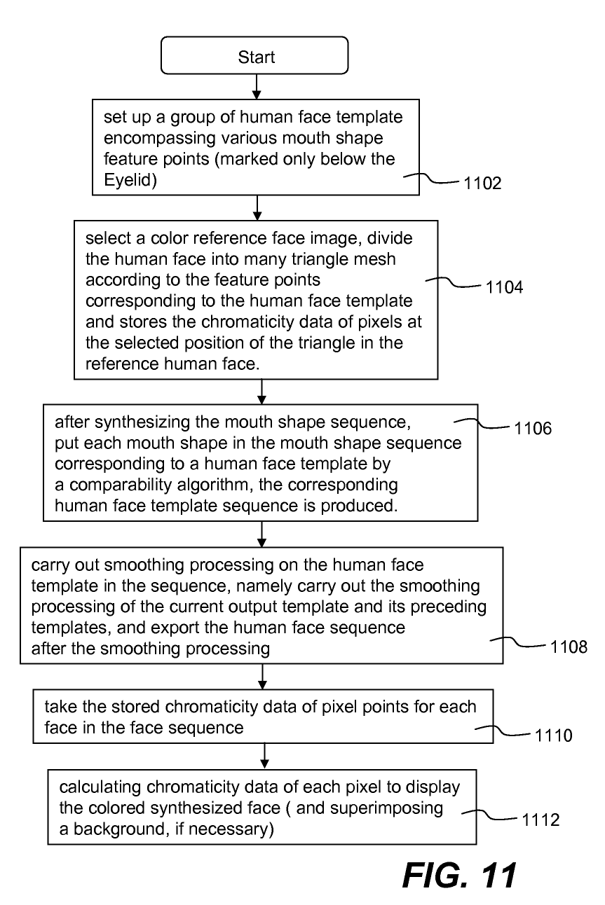

FIG. 11 shows a flowchart or process 1100 of synthesizing a human face according to one embodiment of the present invention. The process 1100 may be implemented in software, hardware or a combination of both and can be advantageously in systems where a facial expression is needed to be synchronized with provided voice data.

At 1102, a group of human face templates are provided to encompass various mouth shape feature points, the feature points are only marked below the eyelids. At 1104, a colorful reference human face image is represented as a mesh (e.g., divided into many triangles according to the feature points corresponding to the human face template) and the corresponding chromaticity data of the pixels at the selected position(s) in the triangles.

At 1106, after synthesizing the mouth shape sequence, each mouth shape is lined up in the mouth shape sequence to produce a corresponding human face template sequence. At 1108, a smoothing processing is carried out on the human face templates in the sequence, namely processing a current output template and its preceding templates, and subsequently exporting the processed human face sequence.

At 1110, for each face in the face sequence, the stored chromaticity data of the abovementioned pixels in the corresponding triangles is used to calculate the chromaticity data of each pixel in the human face at 1112 for eventually displaying the colored synthesized face. When displaying the face, the part above the eyelid, referred to as a fact background herein, is superimposed over the colored synthesized partial face. If necessary, an appropriate background may be also superimposed. FIG. 9 shows two adjacent complete synthesized faces.

In one embodiment, the feature points are distributed on the entire human face, no face background image is required. Thus the operation at 1102 is to resolve the problem of setting up models for the movements of other parts of a face when the mouth opens and closes, which is resolved according to the following steps.

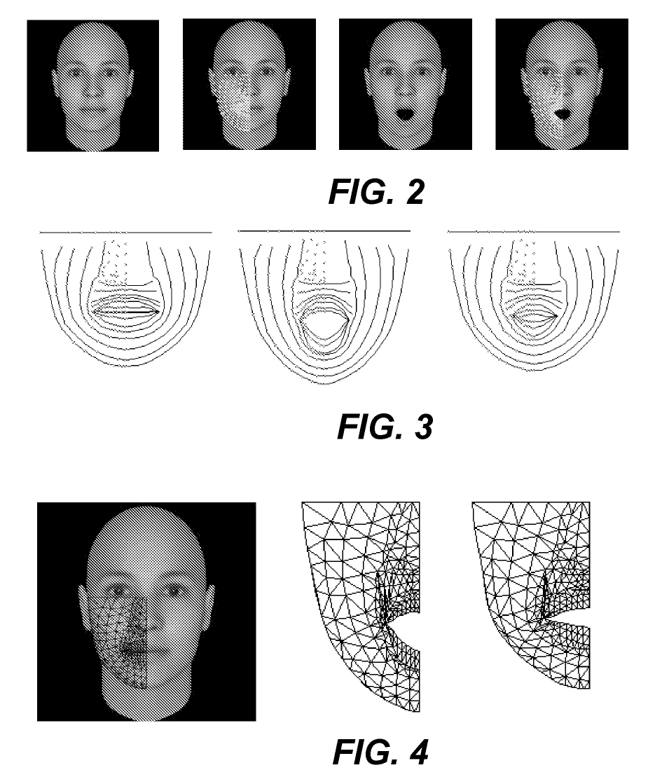

Step A, selecting more than ten standard human face images corresponding to different mouth shapes, as shown in FIG. 2, these images are symmetrical on right and left;

Step B, manually marking more than one hundred feature points on each image, preferably these feature points are distributed under the eyelids, near the mouth, chin and near the nose. There shall be a significant number of the feature points near the mouth shape; and

Step C, getting various feature point aggregation from all standard images (the point and the point in the feature point collection is one to one correspondence, but the position is changeable in accordance with the movement of each part), and carrying out a clustering processing and an interpolation processing, and thus getting 100 new points which form 100 human face templates. FIG. 3 shows a part of the human face model.

According to one embodiment, after receiving video and voice data, both of the image and voice are processed. Various human face templates composed of feature points are determined, which include all kinds of mouth shapes as well as the mapping models reflecting the corresponding relationship between the voice feature and face shape.

Because the selected standard human face images have encompassed various mouth shapes, while the positions of each point on the human face are manually demarcated, the accuracy is relatively high, the human face templates are gained from the demarcated data clustering and interpolation, the gained human face sequence includes all feature point movement information of the human face.

One of the features in the present invention is to quickly and accurately color the synthesized human face. When people speak, the feature points on the face are constantly changing. But if the external lighting is stable and the person's posture keeps static, basically, the color of each point on the face remains relatively unchanged from one image to image. Thus at operation 1102, at first establishing a color face model based on a reference human face image, which can be realized by the following steps in one embodiment:

selecting a colorful reference human face image (for example, closed-mouth shape), with a corresponding human face template, feature points on the human face template divide the human face into a mesh composed of many triangles, as shown in FIG. 4; and

selecting pixels at, for example, 16 positions in each triangle which constitute a grid of the triangle, capturing the chromaticity data of these points in the reference image.

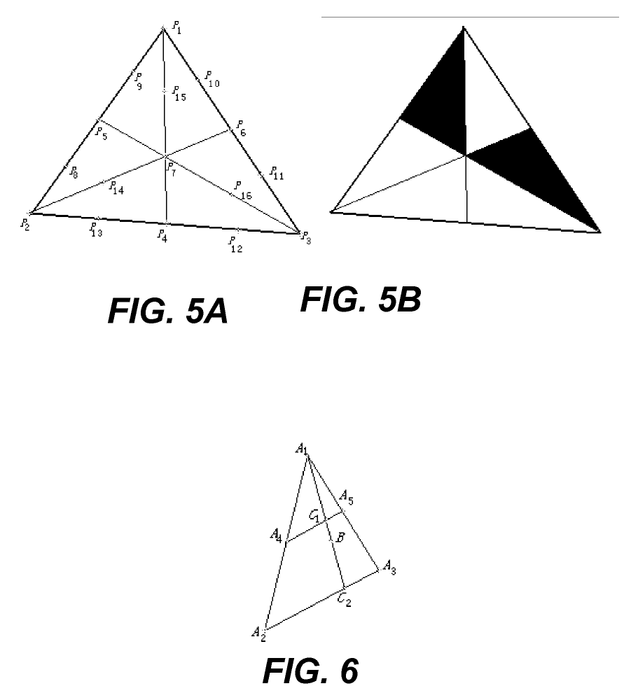

The positions of these points are shown in FIG. 5A, of which P1, P2, P3 are three apexes, P4, P5, P6 are the midpoints of three sides P1-P2, P2-P3, and P3-P1. P7 is a point of intersection of three midlines of P1-P4, P2-P6, and P3-P5. P8, P9, P10, P11, P12, P13 are the respective midpoints of P2-P5, P5-P1, P1-P6, P6-P3, P3-P4, and P4-P2. P14, P15, P16 are the midpoints of P2-P7, P1-P7, and P3-P7.

It is observed that, P1, P2, P3, P4, P5, P6 and P7 as the apex, the triangle P1-P2-P3 can be divided into six small triangles of P1-P7-P6, P1-P7-P5, P2-P7-P5, P2-P7-P4, P3-P7-P4 and P3-P7-P6, as shown in FIG. 5B. Each small triangle has three apexes and two central chromaticity data are known. The abovementioned two steps may be used to perform the coloring.

According to another embodiment, more than three points may be selected. When determining exactly how many points to be used, two factors such as computation load and effect shall be considered. For example, 8˜24 points, besides the number, the position of the points shall be adjusted, and preferably distributed evenly. According to still another embodiment, one can manually set up the grid, namely connecting the feature point to form a mesh or grid. Thus one can change the shape of the grid as required, or the position with more feature points. By adjusting these, one may appropriately reduce the grid numbers to reduce computation load.

In an output human face sequence, the feature points of a human face and a reference human face image are one to one correspondence, so these feature points can form the corresponding triangle grid in the reference human face image. Although the position of each feature point can be changeable, the triangles on two human faces can be corresponding to each other. It is assumed that the lighting is stable, the chromaticity data of the pixels on the corresponding positions of each triangle are substantially similar to that of the pixels of the corresponding positions of the corresponding triangle in the reference image.

According to one embodiment, coloring a synthesized human face is conducted according to the following steps:

Step 1, for each triangle divided by the feature points on a synthesized human face, find out the triangle in the reference human face image corresponding to it, and determine the chromaticity data of pixels in the selected positions of the triangle in the synthesized human face;

Step 2, for six small triangles included in each triangle, calculate the chromaticity data of all pixel points inside each small triangle;

taking small triangle A1A2A3 as an example, the apexes of this small triangle are denoted with A1, A2, A3, as shown in FIG. 6, of which, the color of A1, A2, A3, A4, A5 are known. To calculate the chromaticity data of any pixels around point B in this small triangle, two steps are needed:

1) connect A1-B, get the coordinates of the pixel point C2 for A1-B and A2-A3, and the coordinates of the pixel C1 for A1-B and the two midpoints of the connecting line, calculate the chromaticity data of the C1 according to the chromaticity data of A4 and A5, calculate the chromaticity data of C2 according to the chromaticity data of A1 and A2; and

2) According to the coordinates of each point, judge if B is between A1 and C1 or between the C1 and C2. If it is between the A1 and C1, calculate the chromaticity data of B according to the chromaticity data of A1 and C1.

According to the chromaticity data of the P1 and P2, calculate the chromaticity data of the P3 which is between the P1 and P2 with an interpolation algorithm, for example, as follows
Pixel(P₃)=[Pixel(P₁)*len(P₂P₃)]+Pixel(P₂)*len(P₃P₁)]/len(P₁P₂)
where Pixel ( ) means the chromaticity data of certain point, len ( ) means the length of the straight line. Other algorithm to calculate the chromaticity data of other point from the known points may also be used.

Accordingly, the chromaticity data of each pixel in each small triangle on the synthesized human face can be calculated. In other words, one can color the synthesized human face according to the calculated chromaticity data, and display the color human face.

It should be noted that the abovementioned calculation method is not the only way, each small triangle can be further divided, taking the triangle A1A2A3 as the example, connect A3 with A4, A4 with A5, to get three smaller triangles. The three apex chromaticity data of each small triangle is known, one can take this smaller triangle as a computation unit initially, connect its internal pixel points with the closest apex to get the coordinates of the pixels on the connecting line and opposite side, and calculate the chromaticity data of the pixel by using an interpolation algorithm, then calculate the chromaticity data of the internal pixel points by using the interpolation algorithm again.

The coloring process is mainly to search the internal pixels of each triangle, and set a new color for each point. The computation load of this process is not heavy, so the efficiency of the process is high. In one implementation, the synchronization of mouth shapes with an input voice is done in real time on a P4 2.8 GHz personal computer.

In other implementations of this invention, one can directly set up a mapping model of the voice and face shape for training. When in synthesis, it can match with the corresponding human face sequence according to the input voice, carry out smoothing processing on the human face sequence, then adopt the coloring means to accomplish the coloring (established a color reference human face model), and eventually export the real time color face image.

In fact, the coloring means in this invention can be used any modes to synthesize the human face sequence, further more, the coloring means in this invention also can be used for other images besides the human face, such as the face of animals.

In one embodiment of the present invention, what is required to be exported is a cartoon human face, namely an image sequence exported by the synthesis algorithm is not required to include color information. In this embodiment, the coloring part may be avoided to adopt a method that sets up a group of human face templates including various mouth shapes. When synthesizing, it is corresponding to the mouth shape sequence according to the voice feature vector sequence, then corresponding to the human face sequence with the mouth shape sequence, which may avoid an entire synthesized human face distortion possibly caused by the non-accurate training data such as chin, etc. A synthesized cartoon human face is shown in FIG. 8.

The present invention has been described in sufficient details with a certain degree of particularity. It is understood to those skilled in the art that the present disclosure of embodiments has been made by way of examples only and that numerous changes in the arrangement and combination of parts may be resorted without departing from the spirit and scope of the invention as claimed. Accordingly, the scope of the present invention is defined by the appended claims rather than the foregoing description of embodiments.

What is claimed is:

1. A method for synchronizing colorful human or human-like facial images with voice, the method comprising:
determining feature points in a plurality of image templates about a face, wherein the feature points are largely concentrated below eyelids of the face
providing a colorful reference image reflecting a partial face image;
dividing the reference image into a mesh including small areas according to the feature points on the image templates;
storing chromaticity data of respective pixels on selected positions on the small areas in the reference image;
coloring each of the templates with reference to the chromaticity data; and
processing the image templates to obtain a synthesized image.

2. The method as recited in claim 1, wherein said coloring each of the templates comprises:
deriving chromaticity data on all pixels in each of the small areas, the pixels are referenced with the respective pixels on the selected positions in the each of the small areas.

3. The method as recited in claim 2, wherein the small areas are triangles.

4. The method as recited in claim 3, further comprising:
further dividing the triangles respectively to smaller triangles;
determining coordinates pf each of the smaller triangles;
interpreting chromaticity data on pixels in the smaller triangles using an interpreting algorithm based on the coordinates.

5. The method as recited in claim 4, wherein the interpreting algorithm is expressed by:
Pixel(P₃)=[Pixel(P₁)*len(P₂P₃)]+Pixel(P₂)*len(P₃P₁)]/len(P₁P₂)
where Pixel ( ) means the chromaticity data of a certain pixel, len ( ) means a length of a straight line and P means a pixel.

6. The method as recited in claim 1, further comprising smoothing the image templates with reference to the colorful reference image.

7. The method as recited in claim 6, wherein said processing the image templates to obtain a synthesized image comprises:
outputting a synthesized facial image synchronized with the voice, wherein the synthesized facial image represents a partial face image before eyelids of a face; and
superimposing the synthesized facial image onto the colorful reference image to produce the synthesized image.

8. An apparatus for synchronizing colorful human or human-like facial images with voice, the apparatus comprising:
a human face template unit determining mouth shape feature points from a sequence of image templates about a face, wherein the mouth shape feature points are used to divide a reference image into a mesh comprised of many small areas;
a chromaticity information unit configured to store chromaticity data of selected pixels of each triangle in the mesh;
a mouth shape-face template matching unit configured to put a synthesized mouth shape to a corresponding human face template via a matching processing, and obtain a human face template sequence;
a smoothing processing unit configured to carry out a smoothing processing on each of the image templates; and
a coloring unit configured to store the chromaticity data that configured to color corresponding areas and positions that have been divided according to the feature points, wherein the coloring unit further calculates or expands chromaticity data of other pixels on the human face.

9. The apparatus as recited in claim 8, further comprising:
a display unit configured to display the colored human face.

10. The apparatus as recited in claim 8, wherein a synthesized facial image synchronized with the voice is produced, the synthesized facial image represents a partial face image before eyelids of a face; and wherein the coloring unit configured is further configured to superimpose the synthesized facial image onto the colorful reference image to produce the synthesized image.
